(19) United States
(12) Patent Application Publication
(10) Pub. No.: US 2010/0146112 A1
(43) Pub. Date: Jun. 10, 2010

(54) EFFICIENT COMMUNICATION TECHNIQUES

(75) Inventors: Yotam Shacham, Palo Alto, CA (US); Guy Ben-Artzi, Palo Alto, CA (US); Alexei Alexevitch, Hertzlia (IL); Amatzia Ben-Artzi, Palo Alto, CA (US); Tal Lavian, Sunnyvale, CA (US); Alexander Glyakov, Petach Tikva (IL); Russell W. McMahon, Woodside, CA (US); Yehuda Levi, Rishon Lezion (IL)

Correspondence Address: CONNOLLY BOVE LODGE & HUTZ LLP, 1875 EYE STREET, N.W., SUITE 1100, WASHINGTON, DC, 20006, US

(73) Assignee: Real Dice Inc., Carson City, NV (US)

(21) Appl. No.: 12/630,239

(22) Filed: Dec. 3, 2009

Related U.S. Application Data
(60) Provisional application No. 61/200,934, filed on Dec. 4, 2008.

(51) Int. Cl. G06F 15/173; G06F 15/16

(52) U.S. Cl. 709/224; 709/247

(57) ABSTRACT

Embodiments of techniques that may be used to improve communication efficiency in a network are provided. One or more versions of one or more communication protocols in the network may be monitored. A document object model of data may be processed at a device to generate raw data. Subsequently, the raw data may be transmitted by the device on the network based on the versions of the communication protocols.

### CROSS-REFERENCE TO RELATED APPLICATION

This application draws priority from U.S. Provisional Patent Application No. 61/200,934, filed on Dec. 4, 2008, and hereby incorporated by reference herein in its entirety.

### FIELD OF THE INVENTION

Various embodiments of the invention may relate to communication in a network and more specifically to improving the efficiency of communication in a network.

### BACKGROUND OF THE INVENTION

Various users across the globe communicate or perform various activities on computer and device networks. Moreover, the users interact with each other through the networks, such as the Internet. Typically, the users use devices like personal computers to interact over the Internet. The users can interact from various Internet websites or social networking sites, for example, Facebook, Myspace, Hi5, and Orkut etc. Recently, the development in mobile devices such as cell phones, smartphones and PDAs, computers, laptops and the like has enabled them to be used for performing various activities on networks such as the Internet. Moreover, the mobile devices can be used for real-time interaction with other users on the network. The interaction or communication can be in the form of chatting, playing interactive online games, browsing, shopping, music, video, banking, business and the like.

The rapid pace of innovation in technology has generated various types of devices and platforms. Moreover, the number of devices is increasing rapidly. For example, there are various operating systems available for the devices such as Windows, Linux, Macintosh, and Symbian, etc. Moreover, a large number of J2ME platforms are available for the mobile devices such as cell phones. Furthermore, the mobile devices have a wide range of capabilities in terms of screen size, screen type, screen resolution, processor, and memory etc. The advancement in technology has enabled multi-user interaction on the network, for example, multi-player games on mobile devices. Moreover, with rapid decline in prices of hardware, advanced and inexpensive devices are readily available. Furthermore, advancements in software, operating systems, and input/output interfaces have enabled the development of high performance media capabilities on devices. Interactive applications such as media games are now being developed which allow multi-user interactions on networks. As a result, the number of users and the requirement for the quality of service in the network is increasing rapidly.

Typically, interactive applications may require constant or very frequent communication between the users. Therefore, a large amount of bandwidth may be required to maintain the communication. The bandwidth available on a device depends on the type of network and the hardware or software of a device. For example, mobile network infrastructures such as in rural areas or otherwise underdeveloped areas may have less bandwidth as compared to infrastructures in a developed cities or areas. As a result, the user with slow network connection experiences latency in communication. Further, the information to be transmitted can be huge depending on the type of application. Moreover, the information to be transmitted can be limited due to a low bandwidth network. Therefore, in case of some applications, for example, competitive online games, this may result in fairness issues. Interactive applications such as chatting or mobile games require real time updating of information, which induces latency in communication. Moreover, the versions of communication protocols supported by devices in the network can be different. Furthermore, the versions of the communication protocols may be updated. Therefore, the efficiency of information transfer may vary across devices and the networks. Furthermore, the scalability of these multi-user applications may depend on the efficiency and quality of service of network communications.

A mechanism may therefore be desirable for efficient communication in the network. Such a mechanism may be able to select the information and protocol to be used for the communication and may use these to maintain good user experience.

### SUMMARY

Embodiments of the invention may provide a method for efficient communication in a network. The method may comprise monitoring one or more versions of one or more communication protocols in the network and processing at a device a document object model of data to generate raw data. Thereafter, the raw data may be transmitted by the device in the network based on the versions of the communication protocols.

Further embodiments of the invention may provide an apparatus for efficient communication in a network. The apparatus may comprise a monitoring module configured to monitor one or more versions of one or more communication protocols in the network. The apparatus may further comprise an analyzer module configured to process a document object model of data to generate raw data; and a transmission module configured to transmit the raw data, wherein the raw data may be transmitted based on the versions of the communication protocols.

Further embodiments of the invention may provide a system for efficient communication in a network. The system may comprise: means for monitoring one or more versions of one or more communication protocols in the network; means for processing a document object model of data to generate raw data; and means for transmitting the raw data, wherein the raw data may be transmitted based on the versions of the communication protocols.

Yet further embodiments of the invention may provide a computer-readable medium containing instructions for performing a method for efficient communication in a network. The method may comprise: monitoring one or more versions of one or more communication protocols in the network; processing at a device a document object model of data to generate raw data; and transmitting the raw data by the device on the network, wherein the raw data may be transmitted based on the versions of the communication protocols.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is an environment where various embodiments of the invention may function;

FIG. 2 is a block diagram of a system for efficient communication in a mobile network, in accordance with an embodiment of the invention;

FIG. 3A is a block diagram illustrating efficient communication between a client and a server in the network, in accordance with an embodiment of the invention;

FIG. 3B is a block diagram illustrating efficient communication between a client and a server in a network, in accordance with another embodiment of the invention;

FIG. 4 is a flow diagram illustrating the processing of data, in accordance with an embodiment of the invention;

FIG. 5 illustrates a flowchart diagram for efficient communication in the network, in accordance with an embodiment of the invention; and

FIG. 6 illustrates a flowchart diagram for efficient communication in the network, in accordance with another embodiment of the invention.

### DETAILED DESCRIPTION OF VARIOUS EMBODIMENTS OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

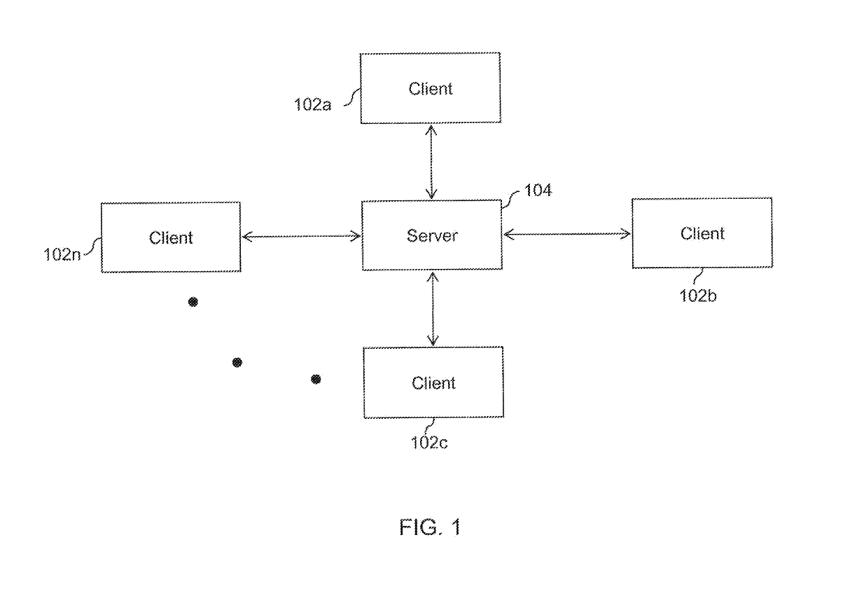

FIG. 1 is an environment where various embodiments of the invention may function. As shown, devices such as client 102a-n may communicate to interact and share information in a network with devices such as a server 104. Clients 102a-n can be, but are not limited to, a mobile phone, a laptop, a personal computer, a smartphone and the like. Similarly, various other devices can be connected in the network through server 104. Clients 102a-n can have different hardware and software platforms. Examples of software platforms include operating systems such as Windows, Linux, Macintosh, Symbian, and so forth. Moreover, clients 102a-n may have different hardware features such as the screen size, screen resolution, audio and video functionality, processors and so forth. Therefore, the applications executing on the clients 102a-n and server 104 may need to be compatible with the operating systems and hardware platforms of these devices.

Clients 102a-n may interact with each other through server 104 in real-time for activities such as chatting, playing games, banking and so forth. Clients 102a-n may interact from different types of network. For example, client 102a may communicate with server 104 through a mobile network with a maximum bandwidth of 14.4 kbps, and client 102b may communicate through an Ethernet network with a maximum bandwidth of 2 Mbps. Moreover, clients 102a-n can have different hardware and software capabilities. For example, client 102a may be a device such as a mobile phone, and client 102b may be device such as a personal computer. Therefore, the communication between clients 102a-n may be based on various network and/or device parameters. Examples of the parameters include, but are not limited to, the bandwidth of the network, the type of network, communication protocols used, latency in communication, a user's online time, processing power of clients 102, processor usage of clients 102, memory of clients 102, and/or other parameters such as electronics, batteries, screen, radio, communications of clients 102 and so forth.

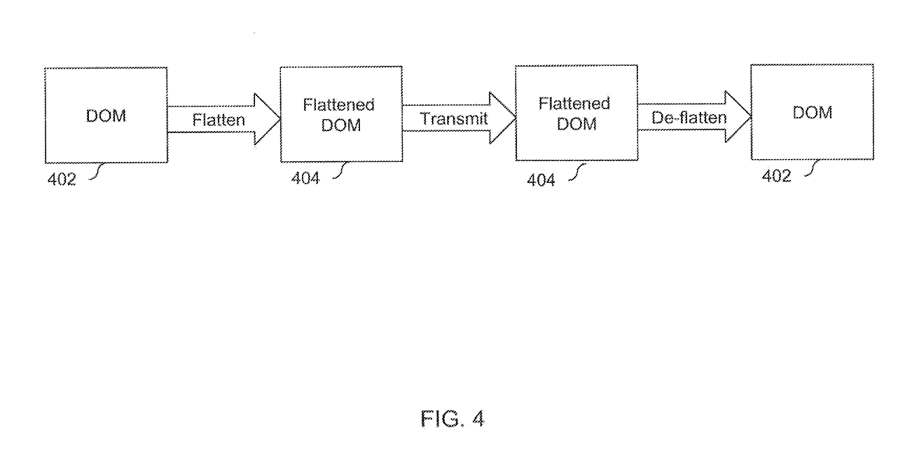

Interactive applications may require a large amount of real-time information transfer between clients 102 and server 104. Therefore, a lot of network bandwidth may be required to avoid latency in the network. For example, in case of interactive multi-player games, real-time information may be transferred regarding the status of the player, statistics of the game, state of the game, game data and so forth. Therefore, mechanisms to improve the efficiency by providing more information on the same bandwidth of the network may be beneficial. However, a large Central Processing Unit (CPU) or processor, memory and more complex logic may be required to enable efficient communication in the network. The processor usage of a device can be offset by the use of additional memory in case of real-time applications. For example, the information that is to be processed can be cached before being processed. As a result, more information can be processed: however, more processing usage may then be required to process the cached data. In an embodiment of the invention, the data to be transferred between clients 102a-n and server 104 is processed before transmitting. The processed data may contain raw data and not complete structural information. As a result, the bandwidth required for transmitting the data may be reduced. The processing of data is discussed in detail in conjunction with FIG. 4. Further, clients 102a-n or server 104 may support different versions of communication protocols. Moreover, the communication protocols may be updated regularly. Examples of versions of protocols include, but are not limited to, Internet Protocol version 4 (IPv4), Internet Protocol version 6 (IPv6), Extensible Messaging and Presence Protocol (XMPP), and so forth. Therefore, for an efficient communication the network may need to be monitored for a protocol version, to be able to select a supported protocol.

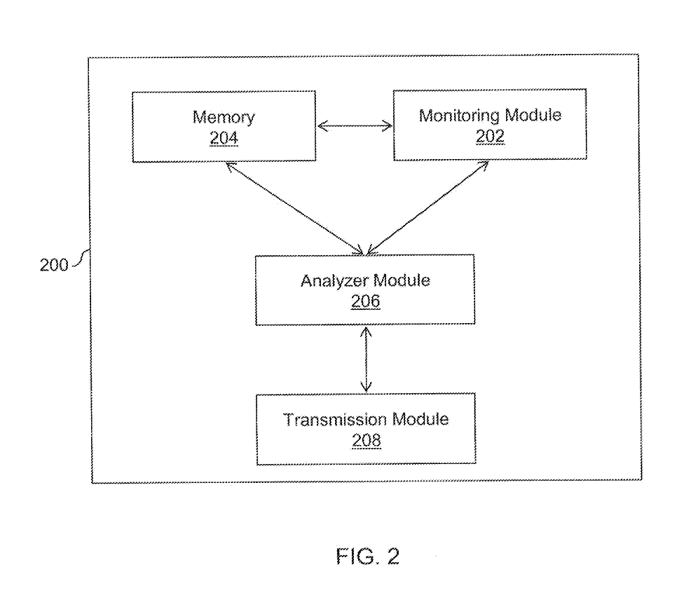

FIG. 2 is a block diagram of a system 200 that may be used to improve communication efficiency in the network, according to an embodiment of the invention. In an embodiment of the invention, system 200 is implemented as a hardware, software or firmware on clients 102a-n and/or server 104. System 200 is hereinafter referred to as adaptor 200.

A real-time application can be executed on adaptor 200. For example, the real-time application can be an online computer game. In such a scenario, client 102 may communicate regularly with server 104 for game information and/or other services. In an embodiment of the invention, server 104 is a game server. Apparatus 200 may include a monitoring module 202 for monitoring the network. In an embodiment of the invention, monitoring module 202 monitors the network for various parameters. For example, monitor module 202 can monitor the network to gather information regarding the protocols used, versions of the protocols, type and amount of data, data to be transmitted and/or bandwidth of the network. In an embodiment of the invention, monitoring module 202 monitors the network regularly after a predetermined time period. In another embodiment of the invention, monitoring module 202 monitors for the versions of the protocols after transmission of every communication message in the network.

Adaptor 200 may include an analyzer module 206 for analyzing the data that is to be transmitted in the network. Analyzer module 206 may analyze the data based on the information gathered by monitoring module 202. Further, analyzer module 206 may select a version of a communication protocol for transmission of data. In an embodiment of the invention, analyzer module 206 selects optimum values for network parameters and device resources. Moreover, analyzer module 206 may process the data to be transmitted in the network. The data to be transmitted may be processed by analyzer module 206 to generate raw data. In an embodiment of the invention, a Document Object Model (DOM) of data may be processed to generate a serialized stream without the structural information. A DOM is a hierarchical representation of fundamental construct relationships; further examples and discussion of DOMs and their construction may be found in co-pending U.S. patent application Ser. No. ______, entitled, “Translation of Programming Code,” filed on ______ (Attorney Docket No. 30036-00004-US), co-assigned, and incorporated by reference herein in its entirety. As a result, the data to be transmitted may be compressed. Moreover, the compressed data can be decompressed by analyzer module 206 by using, e.g., standard compression mechanisms. For example, analyzer module 206 may use standard compression algorithms such as ZIP to compress the data. Therefore, the compression ratio of the data may be increased and may be higher than standard compression algorithms. The compression ratio can be defined as the ratio of the size of compressed information to the size of uncompressed information. Analyzer module 206 can analyze the raw data to generate DOM of the data. Moreover, analyzer module 206 can decompress the data that was earlier compressed using, e.g., standard compression techniques. The raw data may be stored in a memory 204. Further, memory 204 may store information regarding various types and/or versions of communication protocols. Examples of memory 204 include, but are not limited to, a Random Access Memory (RAM), a Read Only Memory (ROM) and so forth.

Adaptor 200 may further include transmission module 208 for transmitting data between server 104 and clients 102a-n. In an embodiment of the invention, transmission module 208 may use transport protocols such as HTTP, TCP, UDP, HTTPS, SIP, or other protocols suitable for mobile networks for transmitting the data. In an embodiment of the invention, transmission module 208 selects the protocol based on the type of network. In another embodiment of the invention, transmission module 208 selects the protocol or the version of the protocol based on the network parameters and/or device resources. For example, transmission module 208 may use tunneling to send data in case the network does not support a particular protocol. For example, HyperText Transfer Protocol (HTTP), File Transfer Protocol (FTP), Secure Shell (SSH) protocols can be encapsulated with a protocol supported by a mobile phone network such as Transmission Control Protocol (TCP).

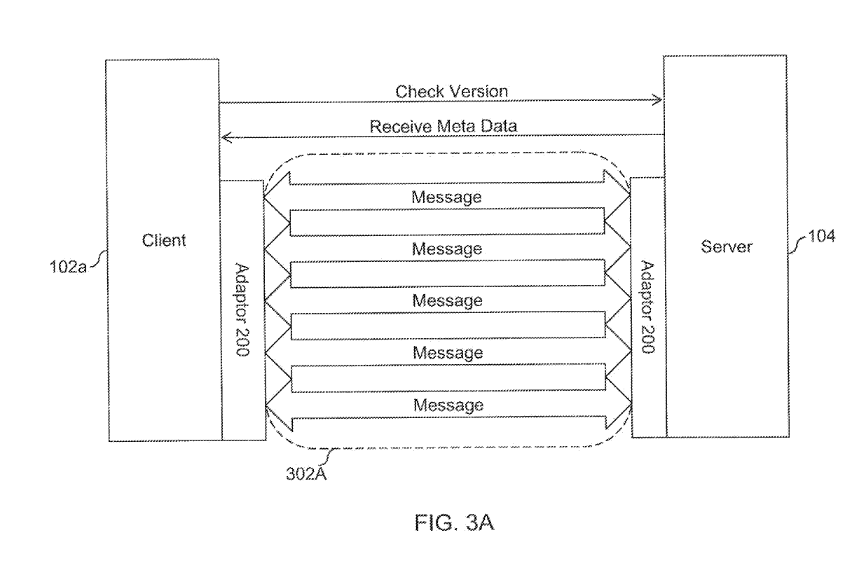

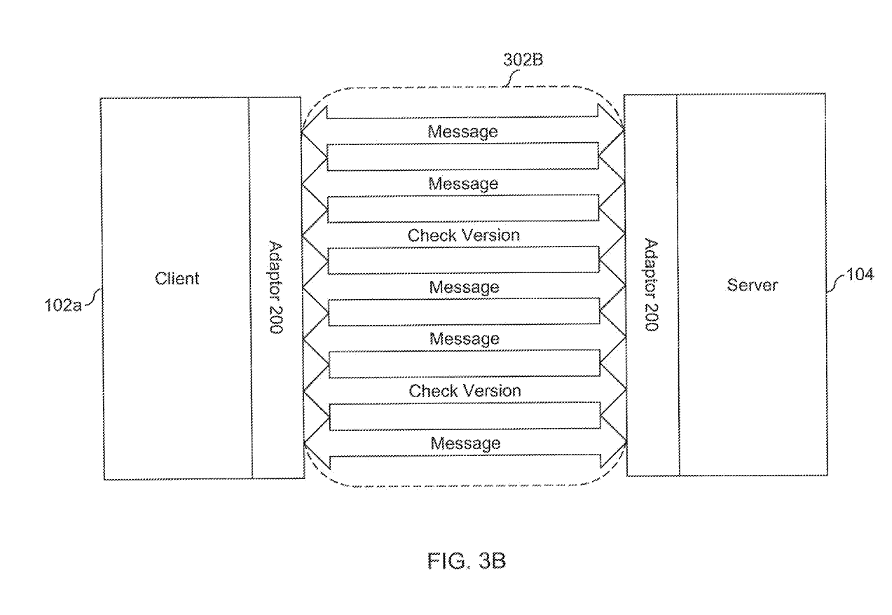

FIG. 3A is a block diagram illustrating efficient communication between client 102a and server 104 in the network, in accordance with an embodiment of the invention. Typically, in network communication, a client may connect to a server, and thereafter the client and the server may pass the data to one another, until one of the two closes the connection. As shown in block 302A of FIG. 3A, client 102a may check server 104 for a version of a protocol supported and may receive the latest meta information. Meta information is data that describes the characteristics of a resource. For example, format, title and author of a file can be referred to as meta information of the information contained in the file. The structure and details of meta information are explained in detail in conjunction with FIG. 4. Thereafter, the information may be transmitted based on the version of the communication protocol and the meta information. The meta information may be transmitted through adaptor 200 as shown in FIG. 3A.

FIG. 3B is a block diagram illustrating an example of communication between client 102a and server 104 in the network, in accordance with another embodiment of the invention. Block 302B depicts the communication between client 102 and server 104 through adaptor 200, in an embodiment of the invention. The data may be transmitted normally, and the checking of the versions may be done regularly. For example, the version may be checked after transmission of every message. Therefore, version checking may be regularly performed across the different messaging or communication protocols in the network. As a result, multiple simultaneous versioning per communication message can be maintained. Moreover, the communication can be switched to new implementations when the latest meta information is available. In an embodiment of the invention, client 102a and server 104 can agree to meta protocols in order to optimize the size of transferred data.

FIG. 4 is a flow diagram illustrating the processing of data, in accordance with an embodiment of the invention. Generally, in case of network communications, the data may be transmitted with complete structural information. For example, a Document Object Model (DOM) may be converted to standard transmission language such as JavaScript Object Notation (JSON). JSON is a text-based and human-readable format to represent data structures and objects. Subsequently, the data may be transmitted and converted back from JSON format to actual DOM at the other end. This process may use processing power to analyze the DOM and read the data stream and memory for construction of the data stream. For example, to convert DOM to JSON, associated processing power may be defined as ‘CPU_{X}’, and memory for stream construction may be defined as ‘X’ bytes. Thereafter, the ‘X’ bytes of data may be transferred in the network. Similarly, the processing power and memory for converting the stream back to DOM may be based on the ‘X’ bytes of transferred data.

As shown in FIG. 4, in accordance with an embodiment of the invention, the data may be processed to generate raw data and then transmitted in the network. In an embodiment of the invention, the raw data includes a header and body. The header of the raw data may contain versioning information and/or other meta-data information. Moreover, the header may include the status of the version. The status for a version can be defined as critical or non-critical. For example, in case the status of the version is non-critical, then the communication can be done if other versions of the protocol are available. Similarly, if the status is critical, then the specific version is used for the communication. The body of the raw data may include the meta information. In an embodiment of the invention, the body of raw data may comprises three basic element types inside a hierarchical structure: primitives such as integers and strings; arrays such as an ordered collection that may be indexed by integers; and dictionaries such as an unordered collection that may be indexed by strings. For example, the meta format in the body can be:

### Example 1

### Meta Format in Case of a Chat Message

{

Name=CHAT,
SenderName=STRING,
Message=STRING

}

As discussed in the example 1, the meta format in case of a chat message can be the ‘Name’ of the application, data type for the name of sender, ‘SenderName,’ and data type of the ‘Message’.

### Example 2

### Meta Format in Case of a User List Message

{

Name=USERLIST,
NumUsers=INTEGER,

USERS = ARRAY of
{

UserName=STRING,
UserID=INTEGER

}}

As discussed in the example 2, the meta format in case of a user list message can be the ‘Name’ of the application, data type for the name of sender ‘UserName, and data type of the ‘UserID’, and the data type for the number of users, ‘NumUsers’.

In an embodiment of the invention, as shown in FIG. 4, DOM 402 of the data may be processed to generate a flattened DOM 404. Flattened DOM 404 may be generated by processing the data to remove structural meta-information. Flattened DOM 404 is raw data obtained from DOM 402. This process may use processing power to analyze DOM 402 and memory for construction of a data stream. For example, for conversion of DOM 402 to flattened DOM 404, processing power may be defined as ‘CPU_{Y}’ for DOM, and the amount of memory for stream construction may be ‘Y’ bytes. Subsequently, flattened DOM 404 may be transmitted on the network. Thereafter, flattened DOM 404 may be processed to generate DOM 402. Similarly, processing power and memory to convert the stream back to DOM may be based on the ‘Y’ bytes of transferred data. As discussed above, the data may be processed to remove structural information and generate raw data, unlike a standard practice where the DOM may be converted to another data exchange format like JSON. Therefore, the amount of memory ‘Y’ bytes may generally be less than ‘X’ bytes. Moreover, the processing power CPU_{Y} may generally be less than CPU_{X} because processing of less bytes may generally be required.

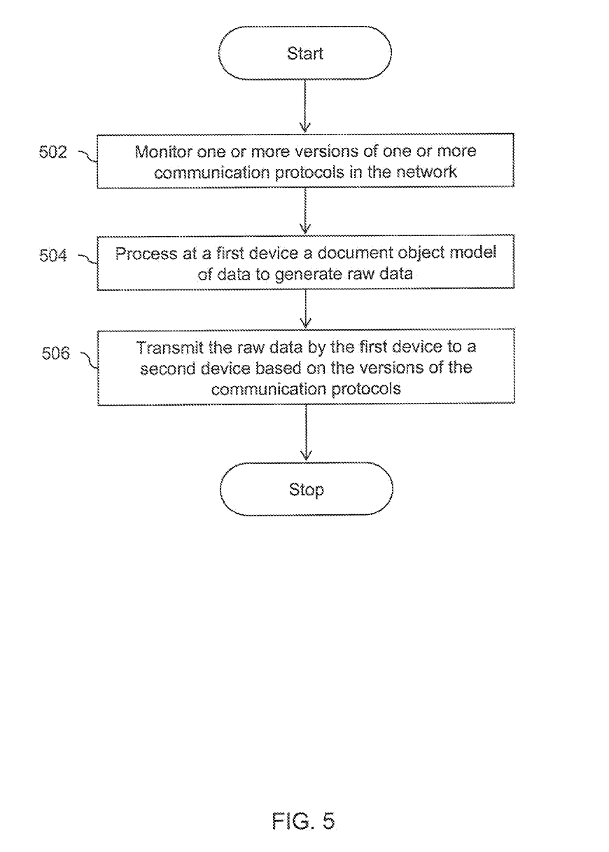

FIG. 5 illustrates a flowchart diagram for communication in the network, in accordance with an embodiment of the invention. The communication in the network can be made efficient by managing the bandwidth and processor usage. At 502, the versioning of communication protocols in the network may be monitored, e.g., by monitoring module 202. Monitoring module 202 may regularly check for changes in the versioning of meta-information.

Thereafter, DOM of data may be processed 504 to generate raw data, e.g., by analyzer module 206. In an embodiment of the invention, the structural information may be removed from the data to generate raw data. In an embodiment of the invention, the raw data may include a header and body. The header of the raw data may contain versioning information, status of the version and/or other meta-data information. Moreover, the header may include the status of the version. The body of the raw data may include meta information. In an embodiment of the invention, the raw data may be further compressed by using standard compression protocols. The versions and the raw data may be stored, e.g., in memory 204. Subsequently, the raw data may be transmitted based on the versions of the communication protocol, e.g., by transmission module 208.

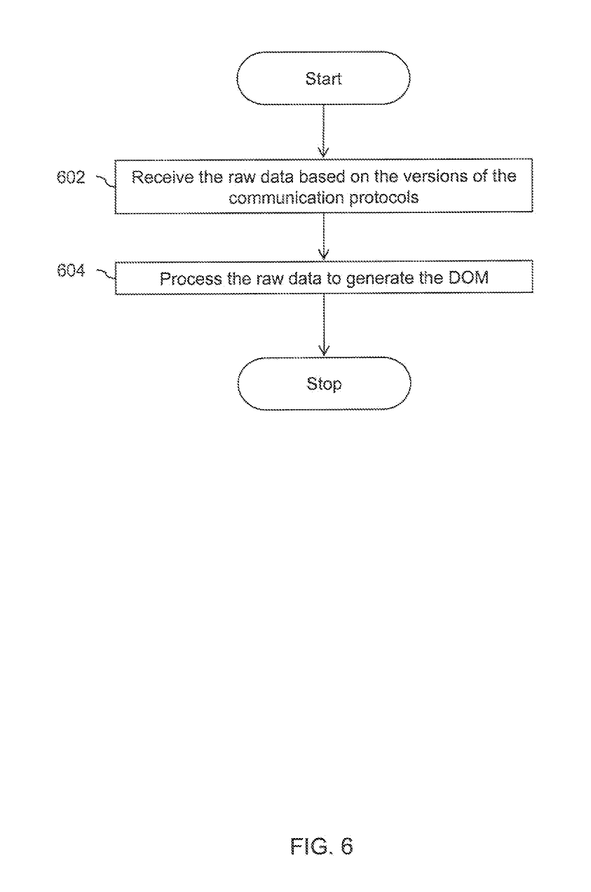

FIG. 6 illustrates a flowchart diagram for communication in the network, in accordance with another embodiment of the invention. The raw data can be received by client 102a-n or server 104 based on the version(s) of the communication protocol(s) used to transmit the data. The raw data may then be processed on reception. At 602, the raw data may received based on the version(s) of the communication protocol(s), e.g., by transmission module 208. Thereafter, at 604, raw data may be processed to generate DOM of the data, e.g., by analyzer module 206. In an embodiment of the invention, structural information may be added to the data to generate DOM of the data by processing information contained in the header and/or the body of the raw data.

While the above embodiments may describe the use of analyzer module 206 and/or transmission module 208 in both transmitting and receiving data, it is further understood that there may be fully or partially separate versions of one or both of these modules used for transmitting and receiving data.

Furthermore, it is also comprehended that monitoring module 202 may be omitted from at least one adaptor 200 of a device in a network, such as a client 102 or a server 104. In such a case, monitoring may be performed at another site, such as at a different device, and may be forwarded to the device for use in transmitting data.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing apparatus or computing devices to produce machines, such that the instructions which execute on the computers or other programmable data processing apparatus create means for implementing the functions specified in the block or blocks. Such computer program instructions may also be stored in a computer-readable medium, such as a memory, that can direct a computing device or other programmable data processing apparatus to function in a particular manner, such that the instructions stored in the computer-readable medium produce an article of manufacture including instruction means that implement the function specified in the block or blocks. Furthermore, such computer program instructions may be provided for download via a network and/or may be downloaded via a network.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A communication method, comprising:
monitoring one or more versions of one or more communication protocols in a network to determine one or more monitored versions of the one or more communication protocols;
processing at a device a document object model of data to generate raw data; and
transmitting the raw data by the device via the network, wherein the raw data is transmitted based on the one or more monitored versions of the one or more communication protocols.

2. The method of claim 1 further comprising:
receiving further raw data at the device; and
processing the further raw data at the device to generate a document object model corresponding to the further raw data.

3. The method of claim 1 further comprising storing the raw data.

4. The method of claim 1, wherein the processing further comprises compressing the raw data.

5. The method of claim 1, wherein the processing further comprises decompressing compressed raw data.

6. The method of claim 1, wherein the raw data comprises a meta information data format.

7. The method of claim 6, wherein the meta information data format comprises a header, wherein the header comprises a version of a communication protocol.

8. The method of claim 7, wherein the header further comprises a status of the version of the communication protocol.

9. The method of claim 6, wherein the meta information data format comprises a body, wherein the body comprises meta information.

10. The method of claim 1, wherein said monitoring comprises dynamically monitoring the versions.

11. The method of claim 1, further comprising downloading computer-executable instructions that, if executed by a computing device, cause the computing device to implement said monitoring, said processing, and said transmitting.

12. The method of claim 1, further comprising providing for downloading computer-executable instructions that, if executed by a computing device, cause the computing device to implement said monitoring, said processing, and said transmitting.

13. A communication method, comprising:
receiving, at a first device, raw data transmitted from a second device over a network, wherein the raw data was transmitted based on one or more versions of one or more monitored communication protocols; and
processing the raw data at the first device to generate a document object model corresponding to the raw data.

14. The method of claim 13, wherein the raw data is received in a compressed format, and wherein said processing includes decompressing the raw data.

15. The method of claim 13, wherein the raw data comprises a meta information data format.

16. The method of claim 15, wherein the meta information data format includes a header that includes a version of a communication protocol used to transmit the raw data.

17. The method of claim 16, wherein the header further includes a status of the version of the communication protocol.

18. The method of claim 15, wherein the meta information data format includes a body that includes meta information.

19. The method of claim 13, further comprising downloading computer-executable instructions that, if executed by a computing device, cause the computing device to implement said receiving and said processing.

20. The method of claim 13, further comprising providing for downloading computer-executable instructions that, if executed by a computing device, cause the computing device to implement said receiving and said processing.

21. An communication apparatus, comprising:
a monitoring module configured to monitor one or more versions of one or more communication protocols in a network to determine one or more monitored versions of one or more communication protocols;
an analyzer module configured to process a document object model of data to generate raw data; and
a transmission module configured to transmit the raw data over the network, wherein the raw data is transmitted based on the one or more monitored versions of the one or more communication protocols.

22. The apparatus of claim 21, wherein the transmission module is further configured to receive raw data at the device; and wherein the analyzer module is further configured to process the raw data at the device to generate a document object model corresponding to the received raw data.

23. The apparatus of claim 21 further comprising a memory configured to store the raw data.

24. The apparatus of claim 21, wherein the analyzer module is configured to compress the raw data.

25. The apparatus of claim 21, wherein the analyzer module is configured to decompress the raw data.

26. The apparatus of claim 21, wherein the raw data comprises a meta information data format.

27. The apparatus of claim 26, wherein the meta information data format comprises a header, wherein the header comprises a version of a communication protocol.

28. The apparatus of claim 27, wherein the header further comprises a status of the version of the communication protocol.

29. The apparatus of claim 26, wherein the meta information data format comprises a body, wherein the body comprises meta information.

30. The apparatus of claim 21, wherein the monitoring module is configured to monitor the versions dynamically.

31. A communication apparatus, comprising:
a transmission module at a first device of a network configured to receive raw data sent by a second device through the network, wherein the raw data was transmitted based on one or more versions of one or more monitored communication protocols; and
an analyzer module configured to process the raw data at the first device to generate a document object model corresponding to the raw data.

32. The apparatus of claim 31, wherein the received raw data is in a compressed format, and wherein the analyzer module is further configured to decompress the raw data.

33. A system for efficient communication in a network, the system comprising:
means for monitoring one or more versions of one or more communication protocols in the network to obtain one or more monitored versions of the one or more communication protocols;
means for processing a document object model of data to generate raw data; and
means for transmitting the raw data, wherein the raw data is transmitted based on the one or more monitored versions of the one or more communication protocols.

34. The system of claim 33, wherein the means for transmitting further comprises:
means for receiving further raw data at the device; and
means for processing the further raw data at the device to generate the document object model corresponding to the further data.

35. The system of claim 33 further comprising means for storing the raw data.

36. The system of claim 33, wherein the means for processing further comprises means for compressing the raw data.

37. The system of claim 33, wherein the means for processing further comprises means for decompressing the raw data.

38. The system of claim 33, wherein the means for monitoring comprises means for monitoring the versions dynamically.

39. A communication system, comprising:
means for receiving raw data transmitted over a network, wherein the raw data was transmitted based on one or more versions of one or more monitored communication protocols; and
means for processing the raw data to generate a document object model corresponding to the raw data.

40. The system of claim 39, wherein the raw data is received in a compressed format, and wherein said means for processing includes means for decompressing the raw data.

41. A computer-readable medium containing program instructions that, if executed by a computing device, cause the computing device to implement a communication method, the method comprising:
monitoring one or more versions of one or more communication protocols in a network to obtain one or more monitored versions of the one or more communication protocols;
processing a document object model of data to generate raw data; and
transmitting the raw data by the device on the network, wherein the raw data is transmitted based on the one or more monitored versions of the one or more communication protocols.

42. The medium of claim 41, wherein the method further comprises:
receiving further raw data; and
processing the raw data to generate a document object model corresponding to the further raw data.

43. The medium of claim 41, wherein the method further comprises storing the raw data.

44. The medium of claim 41, wherein the processing further comprises compressing the raw data.

45. The medium of claim 41, wherein the processing further comprises decompressing the raw data.

46. The medium of claim 41, wherein the raw data comprises a meta information data format.

47. The medium of claim 46, wherein the meta information data format comprises a header, wherein the header comprises a version of a communication protocol.

48. The medium of claim 47, wherein the header further comprises a status of the version of the communication protocol.

49. The medium of claim 46, wherein the meta information data format comprises a body, wherein the body comprises meta information.

50. The medium of claim 41, wherein the monitoring comprises dynamic monitoring.

51. A computer-readable medium containing program instructions that, if executed by a computing device, cause the computing device to implement a communication method, the method comprising:
receiving, at a first device, raw data transmitted from a second device over a network, wherein the raw data was transmitted based on one or more versions of one or more monitored communication protocols; and
processing the raw data at the first device to generate a document object model corresponding to the raw data.

52. The medium of claim 51, wherein the raw data is received in a compressed format, and wherein said processing includes decompressing the raw data.
